(19) United States
(12) Patent Application Publication
(10) Pub. No.: US 2025/0058418 A1
(43) Pub. Date: Feb. 20, 2025

(54) SYSTEMS AND METHODS FOR CONTROLLED MACHINING FLUID DISTRIBUTION

(71) Applicant: Fusion Coolant Systems, Inc., Canton, MI (US)

(72) Inventors: Steven J. Skerlos, Ann Arbor, MI (US); Scott Jones, Royal Oak, MI (US); Virgil Patton, Jackson, MI (US)

(73) Assignee: Fusion Coolant Systems, Inc., Canton, MI (US)

(21) Appl. No.: 18/799,564

(22) Filed: Aug. 9, 2024

Related U.S. Application Data
(60) Provisional application No. 63/519,475, filed on Aug. 14, 2023.

(51) Int. Cl. B23Q 11/10

(52) U.S. Cl. CPC B23Q 11/10

(57) ABSTRACT

Machining systems, fluid distribution systems, and methods are provided by the present disclosure. Certain aspects relate to fluid distribution using manifolds comprising one or more nozzles for fluid distribution. Some such manifolds may moved between an extended and retracted configuration to place a machining tool of a machining system in an interior opening of the manifold for delivery of a machining fluid to the machining tool and/or an associated machining interface from the manifold. Some aspects relate to adaptive control of fluid distribution systems and machining systems in order to improve machining.

### CROSS-REFERENCE TO RELATED APPLICATIONS

This application claims the benefit of priority under 35 U.S.C. § 119(e) of U.S. Provisional Application Ser. No. 63/519,475, filed Aug. 14, 2023, the disclosure of which is incorporated herein by reference in its entirety.

### FIELD

Disclosed embodiments are related to fluid distribution for machining systems, including for machining systems utilizing supercritical machining fluids. Some embodiments relate to tooling for such machining systems.

### BACKGROUND

Machining tools, such as milling systems, lathes, computer numerical control (CNC) systems, drills (e.g., robotic drills), and/or machining centers may employ machining fluids such as metalworking fluids to provide cooling and/or lubrication during a cutting or forming process. The machining fluids may be delivered to an interface between a cutting tool and a workpiece during a cutting or forming process. In some applications, the machining fluid may be delivered externally, such as by routing the machining fluid through a series of pipes and to one or more nozzles that direct the machining fluid toward the machining interface. In other applications, the machining fluid may be routed internally to the interface, such as through a tool holder and/or through a cutting tool (e.g., through one or more channels formed in a cutting tool).

Conventional machining fluids may comprise mixtures including a cooling fluid (such as air, water, liquid carbon dioxide, or liquid nitrogen) to cool a cutting zone and a lubricant (such as oil, a minimum quantity lubrication (MQL) fluid, or synthetic fluids) to lubricate the cutting zone during a cutting process. In some instances, a machining fluid only including an oil, emulsion, or a synthetic fluid may be suitable. In some applications supercritical fluids, such as supercritical carbon dioxide (scCO₂) have been utilized as a portion of a machining fluid.

### SUMMARY

In one aspect, a fluid distribution system is provided. According to some embodiments, the fluid distribution system comprises: a manifold partially surrounding an interior opening of the manifold, wherein the interior opening extends from a first surface of the manifold to a second opposing surface of the manifold, wherein the interior opening is configured to accept a machining tool positioned therein, and wherein the manifold includes a gap through which the machining tool may laterally pass into the interior opening of the manifold in a direction that is at least partially perpendicular to a longitudinal axis of the interior opening; one or more actuators configured to move the manifold between a first retracted configuration and a second extended configuration; one or more nozzles disposed on the manifold; a machining fluid inlet of the manifold in fluid communication with the one or more nozzles; and a vertical motion stage configured to change a vertical position of the manifold.

In another aspect, a fluid distribution system is provided. According to some embodiments, the fluid distribution system comprises: a manifold partially surrounding an interior opening of the manifold, wherein the interior opening extends from a first surface of the manifold to a second opposing surface of the manifold, wherein the interior opening is configured to accept a machining tool positioned therein; one or more nozzles disposed on the manifold; and a machining fluid inlet of the manifold in fluid communication with the one or more nozzles, wherein the one or more nozzles comprise a plurality of nozzles that includes a first group of nozzles directed towards a first focal location and a second group of nozzles directed towards a second focal location different from the first focal location.

In still another aspect, a method of machining is provided. According to some embodiments, the method comprises: moving a manifold including one or more nozzles disposed thereon from a first retracted configuration spaced apart from a first machining tool towards a second extended configuration, wherein moving the manifold from the first retracted configuration towards the second extended configuration includes a lateral movement of the manifold relative to a longitudinal axis of the first machining tool; passing the first machining tool through a gap formed in the manifold into an interior opening of the manifold as the manifold is moved from the first retracted configuration towards the second extended configuration such that the first machining tool extends through the interior opening of the manifold when the manifold is in the second extended configuration; and moving the manifold in a direction that is at least partially parallel to a longitudinal axis of the machining tool when the manifold is in the extended configuration.

In still another aspect, a method of machining is provided. According to some embodiments, the method comprises: moving a manifold including one or more nozzles disposed thereon from a first retracted configuration spaced apart from a first machining tool towards a second extended configuration; passing the first machining tool through a gap formed in the manifold into an interior opening of the manifold as the manifold is moved from the first retracted configuration towards the second extended configuration such that the first machining tool extends through the interior opening of the manifold when the manifold is in the second extended configuration; and directing supercritical fluid to a machining interface via one or more nozzles of the manifold, wherein the one or more nozzles comprise a plurality of nozzles that includes a first group of nozzles directed towards a first focal location and a second group of nozzles directed towards a second focal location different from the first focal location.

In another aspect, a method is provided. According to some embodiments, the method comprises: obtaining a location of a machining interface; and based at least in part on the machining interface location, changing a trajectory of one or more flows of supercritical machining fluid directed from a manifold towards the machining interface location.

In one aspect, a method is provided. According to some embodiments, the method comprises: directing one or more flows of supercritical machining fluid from a manifold towards a machining interface; obtaining a property of the machining interface; and controlling a flow parameter of the one or more flows of supercritical machining fluid based at least in part on the machining interface property.

In another aspect, a method is provided. According to some embodiments, the method comprises: directing one or more flows of supercritical machining fluid from a manifold towards a machining interface; obtaining a property of the machining interface; and controlling machining of the machining interface based at least in part on the machining interface property.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIGS. 1A-1B present schematic representations of a manifold, according to some embodiments;

FIGS. 2A-2B present schematic representations of a fluid distribution system and a machining system, according to some embodiments;

FIG. 3 presents a schematic representation of a fluid distribution system, a machining system, and a workpiece according to some embodiments;

FIG. 4 presents a schematic representation of a fluid distribution system comprising multiple rotatable linkages, according to some embodiments;

FIGS. 5A-5B present schematic representations of a manifold comprising multiple nozzle groups, according to some embodiments;

FIG. 6 presents a schematic representation of a method of machining, according to some embodiments;

FIGS. 7A-7C present schematic representation of methods of a method of machining, according to some embodiments; and

FIG. 8 presents a schematic representation of a fluid distribution system comprising multiple manifolds.

### DETAILED DESCRIPTION

Improvements in fluid distribution for machining systems, particularly for machining systems capable of performing rapid tool changes, are generally provided. In some aspects, improved fluid distribution systems, methods, and machining systems are described. The improvements herein are, in some embodiments, related to improvements in machining using a supercritical machining fluid, such as supercritical carbon dioxide (scCO₂) or supercritical nitrogen. The inventors have appreciated that supercritical machining fluids may provide numerous benefits compared to conventional machining fluids, such as water-based machining fluids, oil-based machining fluids (e.g., neat oils, minimum quantity lubrication (MQL) fluids, or synthetic machining fluids). As recognized herein, distribution of a machining fluid in close proximity to a workpiece may be particularly advantageous when the machining fluid is a supercritical machining fluid given the rapid expansion of supercritical fluids once exposed to atmospheric temperature and pressure. Certain improvements described herein facilitate rapid tool changing in machining systems relying on supercritical machining fluids for cooling and/or lubricating a workpiece. According to some embodiments, the present disclosure relates to rapid insertion and/or removal of a fluid distribution systems relative to a machining tool which may help to facilitate rapid tool changes though other benefits different from those noted above are also possible.

The present disclosure is directed, in some aspects, towards the use of a manifold to deliver a fluid, such as a supercritical machining fluid, to a machining interface associated with one or more machining tools of a machining system. The manifold may comprise a body that extends at least partially around (i.e., partially surrounds) an interior opening that is configured to accept a machining tool positioned therein. The manifold may include a gap through which a machining tool may laterally pass from an exterior of the manifold and into the interior opening (e.g., as the manifold moves during a change in configuration). The manifold may be configured to facilitate the movement of the manifold relative to one or more machining tools during operation such that the manifold may be moved relative to the machining tool (e.g., by being mounted on one or more motion stages or by being mounted on a lead screw) as further elaborated on below. The use the disclosed lubrication systems and associated manifolds is recognized herein as particularly advantageous for certain applications of supercritical machining fluids in machining systems. For example, the disclosed systems and methods may be particularly well suited for rapid changes in manifold configuration, which may facilitate rapid tool changes in a machining system, though other benefits, including benefits different than those noted above are also possible.

To facilitate the tool changes and/or adjustment of the delivery of supercritical machining fluid to an interface, a fluid distribution system may be configured to change a pose of a manifold configured to deliver a supercritical machining fluid relative to an associated machining interface and/or machining tool. Changing the manifold configuration may be useful in the context of tool changing, since placing a manifold too close to a first machining tool can obstruct removal of the machining tool and/or installation of a second machining tool. Thus, the manifold may be configured to move between a first, retracted configuration, and a second, extended configuration (e.g., through the use of one or more actuators of a fluid distribution system). In the first, retracted configuration, the manifold may be removed from the machining interface and/or machining tool such that the machining tool is disposed outside of the interior opening formed in the manifold, according to some embodiments. In the second, extended configuration, the manifold may at least partially surround the machining tool. For example, the machining tool may be disposed within the interior opening of the manifold when the manifold is in the extended configuration. The manifold may transition between the first, retracted configuration and the second, extended configuration by transitioning through one or more intermediate configurations, each of which may be classified as either extended or retracted based on whether or not the manifold is configured to at least partially surround the machining tool. For example, the manifold may pass through a third, retracted configuration as it transitions between the first, retracted configuration and the second, extended configuration.

The manifold may be in an appropriate pose to direct supercritical machining fluid towards a machining interface of the tool when the manifold is in the second, extended configuration. In some embodiments, the manifold is used to distribute machining fluid without surrounding a machining tool. According to some embodiments, the manifold is in an appropriate pose to direct supercritical machining fluid towards a machining interface of the tool when the manifold is in a retracted configuration. For example, in some embodiments the fluid distribution system is configured to move the manifold from a first, retracted configuration to a second, retracted configuration closer to the machining tool than the first, retracted configuration. In the second, retracted configuration, the manifold may be configured to distribute supercritical fluid to a machining tool and/or a workpiece, while in the first, retracted configuration, the manifold is not configured to distribute supercritical fluid to a machining tool and/or a workpiece. According to some embodiments, it may be advantageous to perform a tool change (e.g., by exchanging a first machining tool for a second machining tool) when the manifold is in the first, retracted configuration rather than a second, extended configuration or a second, retracted configuration closer to the machining tool, since the manifold is less of an obstruction to tool changing when it is further removed from and does not at least partially surround the machining tool.

While any set of movements may be used to transition a manifold between a retracted and extended configuration, in some embodiments, one or more motion stages associated with the manifold may be configured to laterally displace the manifold relative to a longitudinal axis of a machining tool of the machining system. This may include rotational movement of the manifold in some embodiments, though combinations of lateral movement, longitudinal movement, and/or rotation of the manifold may be used as the disclosure is not so limited. In some such embodiments, the manifold may be configured such that when the manifold moves from the first, retracted configuration to the second, extended configuration, the machining tool passes laterally through the gap of the manifold and into the interior opening of the manifold. Relatedly, in some embodiments, the manifold is configured such that when the manifold moves from the second, extended configuration to the first, retracted configuration, the machining tool laterally passes through the gap from the interior opening to an exterior of the device as the manifold is moved.

It should be understood that the making of many parts includes multiple types of machining processes using different types of machining tools. Thus, in some embodiments, tool changing may be performed when the manifold is in the retracted configuration. For example, in some embodiments, a first machining tool and a first tool holder are removed from the machining system and a second machining tool in a second tool holder is subsequently installed in the machining system while the manifold of a system is in the retracted configuration. As another example, in some embodiments, a first machining tool is removed from a tool holder of the machining system and a second machining tool is subsequently installed in the tool holder of the machining system while the manifold of a system is in the retracted configuration. As another example, the machining system may include a plurality of machining tools (e.g., installed in a plurality of tool holders) and may perform a tool changing operation by withdrawing the first machining tool from a workpiece and subsequently inserting a second machining tool towards the workpiece. A tool change may be performed automatically (e.g., in response to a pre-programmed, processor-executable set of instructions configured to actuate a tool change), manually (e.g., by a process of manually moving the first machining tool and the second machining tool), or by any of a variety of suitable combinations of automatic and manually performed steps, as the disclosure is not so limited.

The manifold may be configured to rapidly move between the first, retracted configuration and the second, extended configuration, e.g., to facilitate rapid tool changes. In some embodiments, the manifold is configured to move between the first, retracted configuration and the second, extended configuration in a period of less than or equal to 30 s, less than or equal to 20 s, less than or equal to 10 s, less than or equal to 5 s, less than or equal to 2 s, less than or equal to 1 s, less than or equal to 500 ms, or less. In some embodiments, the manifold is configured to move between the first, retracted configuration and the second, extended configuration in a period of greater than or equal to 100 ms, greater than or equal to 200 ms, greater than or equal to 500 ms, greater than or equal to 1 s, greater than or equal to 2 s, greater than or equal to 5 s, greater than or equal to 10 s, greater than or equal to 20 s, or greater. Combinations of these ranges are possible. For example, in some embodiments, the manifold is configured to move between the first, retracted configuration and the second, extended configuration in a period of greater than or equal to 100 ms and less than or equal to 30 s. Other ranges, both higher and lower than those described above, are also possible, as the disclosure is not so limited.

It should, of course, be understood that changing the manifold from the first, retracted configuration to the second, extended configuration and changing the manifold from the second, extended configuration to the first, retracted configuration may each, independently be accomplished within one of the time periods described in the preceding paragraph.

The manifolds described in the various embodiments disclosed herein may comprise any of a variety of suitable materials that are compatible with the supercritical machining fluids disclosed herein. For example, in some embodiments, the manifold comprises a metal (e.g., steel or aluminum). Additionally, the supercritical fluid distribution channels may be formed in any appropriate manner in the disclosed manifolds. This may include, for example, drilling, casting, electrical discharge machining, sealed channels formed in assembled portions of the manifold, and/or using any other appropriate formation method.

A manifold may be configured to distribute machining fluid (e.g., to a workpiece and/or to a machining tool) using any of a variety of appropriate methods. For example, one or more nozzles may be disposed on, or formed in, the manifold. The term “nozzle” as used herein may refer to a part comprising an orifice or to an integrally formed portion of the manifold comprising an orifice. For example, in some embodiments, the manifold comprises an orifice configured to direct machining fluid in a direction perpendicular to a flat surface of the manifold. As another example, in some embodiments the nozzle is an insert (e.g., a glass or ceramic insert) comprising an orifice and configured to be inserted into a hole of the manifold such that machining fluid from the manifold is directed out of the nozzle via the orifice. In either case, ti should be understood that a nozzle as used herein may refer to any structure capable of directing a flow of supercritical machining fluid in a desired direction.

In some embodiments, a nozzle is configured to direct a spray of the machining fluid from the manifold towards the machining interface of a machining tool with a part being machined. According to some aspects, the size of the orifices associated with the nozzles formed in a manifold may be selected to provide a desired combination of pressure and flow characteristics for a supercritical machining fluid. In particular, the inventors have recognized that particular ranges of orifice diameters may provide desirable pressure and flow characteristics for different applications to match the characteristics of other components of a machining system, including the pumping architecture associated with the supercritical machining fluid. For example, a diameter or other maximum transverse dimension of the orifice(s) may be greater than or equal to about 50 μm, 100 μm, 150 μm, 200 μm, and/or any other appropriate dimension. Correspondingly, the diameter or other maximum transverse dimension of the orifice(s) may be less than or equal to 500 μm, 400 μm, 300 μm, 200 μm, and/or any other appropriate dimension. Combinations of the foregoing are contemplated including a maximum transverse dimension of the orifice(s) that is between or equal to about 50 microns and about 500 microns (e.g., about 150 microns). The inventors have further appreciated that such orifice transverse dimensions, while providing numerous benefits when used in connection with supercritical machining fluids as described herein, may not be suitable for use with conventional machining fluids such as water-based emulsions. For example, many conventional water-based machining fluids would likely not flow through such small orifices due to surface tension effects, and the lubricants suspended in some conventional machining fluids (e.g., liquid CO₂) would likely clog the orifice(s). In contrast, supercritical machining fluids may easily flow out of such a small orifice. Moreover, oils or other suitable lubricants may be soluble or otherwise easily dispersed in supercritical machining fluids such as scCO₂ such that the oils do not clog the orifices. Of course, it should be understood that nozzles described herein may be chosen for compatibility with supercritical machining fluids or with conventional machining fluids, as the disclosure is not limited to the use of any particular machining fluid.

In some embodiments, the diameter, or other transverse dimension, of the orifice(s) may be selected based on the number of nozzles that may be used with a tool in a particular application. For example, in applications in which a large number of nozzles is desirable to provide delivery of machining fluid to multiple locations along a tool and/or machining interface, smaller diameter orifices may be beneficial. In other applications, fewer nozzles may be used (e.g., as few as one), and correspondingly, the nozzle orifice(s) may be larger (e.g., about 500 microns). In some embodiments, three or more nozzles may be included in a manifold to deliver supercritical fluid to a machining interface from three separate locations on a manifold distributed circumferentially around a machining tool during use.

Nozzles described herein may be integrally formed with the manifold (e.g., the nozzle may be a part of the rigid body of the manifold), may be joined to the manifold (e.g., by welding), may be mechanically coupled to the manifold (e.g., mechanical interlocking parts, threading, etc.), and/or using any other appropriate type of connection. The nozzles may be made from any of a variety of suitable materials. For example, nozzles integrally formed with the manifold may be made from any of the above-mentioned materials suitable for use in manifolds. A nozzle that is separately formed and connected to a manifold may be made using any appropriate material that is suitable for supporting the applied pressures and temperatures during lubrication of a machining interface including, for of the materials suitable for use in the manifold itself. In some embodiments, for example, a nozzle comprises glass (e.g., quartz glass, sapphire glass), metal, combinations of the forgoing, and/or any other appropriate material. Depending on the particular embodiment, nozzle orifices may be formed via any suitable method. For example, in some instances, the orifices may be formed by machine drilling, laser drilling, electrical discharge machining (EDM), and/or any other appropriate method.

Certain advantages may be associated with the selective use of some or all of the one or more nozzles of the manifold. Thus, in some embodiments, a fluid distribution system includes a plurality of valves configured to control fluid flow through at least some of the one or more nozzles. This may include separate valves associated with separate channels and/or nozzles formed in the manifold. In some embodiments, the number of valves equals the number of nozzles of the manifold and the flow through each nozzle may be controlled using a separate associated valve. However, in some embodiments, the number of valves is less than the number of nozzles. For example, a valve may individually control a flow of fluid through a plurality of nozzles fluidically coupled to the valve. In some embodiments, the plurality of valves is used to selectively control fluid flow through a first group of one or more nozzles and a second group of one or more nozzles. Such a configuration may provide certain advantages for the distribution of machining fluid. For example, the first plurality of nozzles may be configured to distribute machining fluid to a first focal location and the second plurality of nozzles may be configured to distribute machining fluid to a second focal location different from the first focal location. The use of multiple nozzle groups may be advantageous for facilitating simultaneous lubrication of a tool and a machining interface, and may have advantages for use with machining systems comprising multiple machining tools, since different focal location may be appropriate for using different machining tools. Thus, in some embodiments, a machining method comprises distributing fluid through a first group of one or more nozzles to a first focal location associated with a first machining tool, performing a tool change to replace the first machining tool with a second machining tool, and distributing fluid through a second group of one or more nozzles to a second focal location associated with the second machining tool.

The manifold may further comprise one or more fluid inlets that allow machining fluid to pass into the manifold. The inlet may be fluidically connected to at least one of the one or more nozzles of the manifold. For example, the inlet may be fluidically connected to all of the one or more nozzles of the manifold, or separate inlets and associated separate channels may be fluidly coupled to separate groups of nozzles as the disclosure is not limited in this fashion. The inlet may have any of a variety of suitable shapes, sizes, and or configurations. In some embodiments, the inlet is connected to a machining fluid supply (e.g. a supercritical machining fluid supply) via any appropriate type of connection. The inlet may be chosen for compatibility with a chosen type of machining fluid. For example, the inlet may be chosen for compatibility with a supercritical machining fluid.

The manifolds and associated fluid distribution systems and machining systems discussed herein may be particularly well-adapted for use with supercritical machining fluids. As used herein, a supercritical fluid refers to a fluid that is maintained above its critical point (i.e., at a temperature above the critical temperature and at a pressure above the critical pressure). For example, the critical temperature and pressure for carbon dioxide are 31.1° C. and 72.8 atm, respectively. Above the critical point, distinct liquid and gas phases do not exist; instead, supercritical fluids exhibit characteristics of both liquids and gases. For example, supercritical fluids may exhibit the flow and expansion behaviors of gasses while also being able to dissolve materials like a liquid. In some embodiments, a fluid distribution system includes a supercritical machining fluid supply, configured to generate, store, and/or maintain machining fluid in a supercritical state. The supercritical machining fluid supply may be fluidically coupled to a manifold as described herein, and may thus be configured to provide supercritical machining fluid to the manifold. Appropriate types of supercritical fluids that may be used with the methods and systems disclosed herein may include, but are not limited to, supercritical carbon dioxide, nitrogen, water, ethane, propane, ethanol, helium, combinations of the forgoing, and/or any other appropriate type of supercritical fluid capable of being used with a machining process as disclosed herein.

According to some embodiments, the disclosure is directed towards the fluid distribution systems configured to deliver expanded supercritical fluid to a machining system. Expansion of a supercritical fluid may occur when the supercritical fluid is exposed to temperature and/or pressure conditions wherein a thermodynamic equilibrium state of the fluid is not supercritical. For example, a supercritical fluid may become an expanded supercritical fluid as it is directed from a nozzle of a manifold towards a cutting interface. An expanded supercritical fluid may comprise a plurality of phases, in some embodiments. For example, an expanded supercritical fluid may comprise a gas and/or a condensed phase. In some embodiments, the expanded supercritical fluid comprises a solid phase. For example, expanded supercritical CO₂ may comprise dry ice condensate and/or ice condensate. In some embodiments, the expanded supercritical fluid comprises a liquid phase. For example, the expanded supercritical fluid comprises a lubricant present in the liquid phase. The expanded supercritical fluid may comprise supercritical fluid, but does not necessarily comprise supercritical fluid. For example, a flow of expanded supercritical fluid flowing from a nozzle of a manifold may comprise supercritical fluid near the nozzle (e.g., as a kinetically unstable phase that has had insufficient time to transition into a more kinetically stable gas or condensed phase) but not far from the nozzle (e.g., where the expanded supercritical fluid has been exposed to ambient conditions for adequate time to be completely consumed). Thus, depending on the position and flow rate of supercritical fluid from the manifold, the manifold may deliver expanded supercritical fluid to the workpiece and the expanded supercritical fluid may but does not necessarily comprise supercritical fluid as a kinetic phase upon reaching the workpiece. Generally, the supercritical fluid may be expanded within the fluid distribution system (e.g., within the manifold) or after exiting the fluid distribution system (e.g., in a flow directed from a nozzle of the manifold)—either option may have associated advantages, depending on the embodiment.

Without wishing to be bound by theory, supercritical machining fluids are not compatible with every material and/or technique used in typical machining systems and tools due to effects such as carbonation of materials; embrittlement; explosive decompression; dissolving of the materials; and other effects. Accordingly, the various seals, O-rings, and joints and interfaces exposed to the supercritical machining fluid of a tool, toolholder, components attached to a toolholder (e.g. coolant pipe, collet, etc.), a spindle, and/or any other appropriate component of a machining system may include materials that are selected to be compatible with the supercritical machining fluid such that these components and systems may be configured for operation with the supercritical machining fluid as compared to typical systems which may not be compatible with the supercritical machining fluid. For example, materials may be selected based on the operating temperature and pressure ranges associated with the supercritical fluid as well as to provide compatibility with the supercritical fluid. For example, operating pressures may be between about 100 and 140 bar, and in some instances, up to about 200 bar, 300 bar, 400 bar or more, and operating temperatures may be between about 20° C. and about 100° C. It should, of course, be understood that operating pressures and temperatures both above and below the forgoing ranges are also possible, as the disclosure is not so limited. In some embodiments, suitable materials for seals and O-rings that can operate in these pressure and temperature ranges and also provide compatibility with supercritical fluids such as scCO₂ include, but are not limited to, perfluoroelastomers (e.g. Kalrez 0090), hard durometer fluoroelastomers (e.g. hard durometer Viton and Viton encapsulated with fluorinated ethylene propylene), hydrogenated acrylonitrile butadiene rubber, and polytetrafluoroethylene (PTFE). In some applications, it may be beneficial to select a high durometer seal or O-ring formed from a suitable material. Moreover, joints that may be suitable for connecting various portions of the systems described herein include, but are not limited to, hydraulic joints such as National Pipe Thread (NPT), British Standard Pipe (BSP and/or BSPP), Joint Industrial Council (JIC), and/or other compression fittings rated to greater than or equal to 200 bar.

For the sake of clarity, a majority of the embodiments described herein are described relative to rotational machining systems that include a rotating toolholder and tool held in the toolholder with corresponding flows of supercritical machining fluid routed through one or both of these components. However, it should be understood that the various embodiments described herein may be used with any appropriate combination of rotational and/or rotationally stationary tools and/or toolholders as the disclosure is not limited in this fashion. This may include, but are not limited to, applications such as milling, drills, lathes, computer numerical control (CNC) machines, grinders, boring machines, broaching machines, honing machines, polishing machines, or planing machines using one or more of the forgoing systems, and/or any other appropriate type of machining system where lubrication may be applied to a machining interface of a work part with a machining tool.

In machining applications, rapidly expanding supercritical machining fluids may provide better cooling and/or more efficient heat transfer, may provide for better mixing with lubricants or dissolution of lubricants, and/or allow for the use of smaller amounts of lubricants compared to conventional water-based machining fluids. However, the distribution of supercritical machining fluids may present significant challenges during machining, and the fluid distribution systems, manifolds, and methods provided herein may be particularly advantageous for overcoming these challenges. For example, supercritical machining fluids may be particularly effective when expanded in close proximity to a machining tool or machining interface. Without wishing to be bound by any particular theory, close proximity of a supercritical machining fluid distribution nozzle to a machining tool or machining interface may also reduce waste of a supercritical machining fluid, may increase the effectiveness of a supercritical machining fluid, and/or may advantageously reduce requisite flow-rates or pressures associated with using a supercritical machining fluid.

In view of the above, a manifold as disclosed herein may be useful for emitting one or more flows of supercritical machining fluid from the manifold towards a machining interface within a predetermined distance of a machining interface. The manifolds, fluid distribution systems, and methods provided herein may therefore be advantageous, both because they facilitate rapid tool changing of a machining system and because, during machining, the manifolds can be used to distribute supercritical machining fluids from nozzles in close proximity to a machining tool or machining interface.

It may be advantageous to control a position of a manifold and the focal location of the one or plurality of streams of supercritical machining fluid relative to a machining interface and machining tool in use. For example, in some embodiments, a tool changing operation results in the replacement of a first machining tool with a second machining tool, and the second machining tool may have a different shape, orientation, and or machining interface location then the first machining tool had prior to the tool change. In some embodiments, a location of a machining interface is obtained using an appropriate method as elaborated on further below. The trajectory of one or more flows of the machining fluid (e.g., the trajectory of the supercritical machining fluid) from a manifold may then be changed, where the change may be based at least in part on the determined machining interface location. Generally, the one or more flows of machining fluid may have linear or non-linear trajectories, depending on the embodiment. Exemplary methods of obtaining machining interface locations and changing machining fluid trajectories are discussed in greater detail with reference to the figures below but may include movement of the manifold relative to a machining interface and/or changing an orientation of the one or more streams of supercritical machining fluid that are emitted from a manifold.

In some aspects, flow of a machining fluid may be controlled based at least in part on a property of the machining interface. For example, the property of the machining interface may be a location of the machining interface (e.g., an absolute location of the machining interface or a location of the machining interface relative to the manifold), a temperature of the machining interface (e.g., an average temperature of the machining interface, a hottest local temperature of the machining interface, or a local temperature at a reference position), a spatial temperature distribution of the machining interface, or a property of the machining fluid that reaches the interface (e.g., machining fluid density, average state of matter of the machining fluid, machining fluid temperature, or machining fluid pressure).

A machining interface property may be used to control a flow parameter of one or more flows of supercritical machining fluid emitted from the manifold. The machining interface property may be used to trigger a pre-defined control response, or could be used more generally to inform a change in a flow parameter by a control system. Controlling the flow parameter may provide a number of advantages for machining. For example, the flow parameter may be changed in order to reduce a temperature of the workpiece, thereby allowing machining to be performed at a high speed without overheating and/or damaging the workpiece. As another example, in the context of supercritical machining fluid distribution, the flow parameters may be adjusted to ensure that a higher proportion of the expanded supercritical machining fluid reaches the machining interface in its supercritical state without first evaporating, thereby facilitating efficient and/or effective use of machining fluids. As another example, a flow parameter could be changed in order to change a rate, size, or trajectory of material being removed from the machining interface (e.g., in the form of chips). A few, non-limiting examples of flow parameters that can be controlled include trajectory of the flow (discussed above), as well as flow rate. The machining interface property may be used to control machining. As with flow properties, controlling machining may be advantageous for managing the temperature of a workpiece. For example, in some embodiments, the machining interface property may be used to change a speed of rotation of a machining tool, to change a feed rate of the machining tool relative to the workpiece, to change a depth of cut of the machining tool, or to perform a tool change.

Controlling machining and/or flow parameters of one or more flows of machining fluid based on machining interface properties may have a number of advantages. For example, in some embodiments, control of machining or control of machining fluid flow may be used to perform a closed-loop machining method. In some embodiments, closed-loop machining methods can be used to rapidly adjust machining based on cutting interface properties (e.g., by removing the need for certain software controls otherwise required by the machining process, speeding up machining, by reducing the frequency or need for tool changes, by reducing vibration (e.g., chatter), and/or by increasing automatic control of the machining process, reducing the difficulty of manually controlling the machining process).

The fluid distribution systems discussed herein may comprise one or more machining fluid supplies. For example, a fluid distribution system may comprise more than one machining fluid supply. A machining fluid supply may be a supercritical machining fluid supply, as discussed briefly above. Though embodiments in which a machining fluid supply provides a non-supercritical machining fluid supply and/or a mixture of a supercritical and non-supercritical fluid are also contemplated. In some embodiments, a machining fluid supply may be configured to store a reserve of a machining fluid for distribution to one or more manifolds associated with one or more separate machines as discussed above.

In some embodiments, a fluid distribution system may be configured to mix fluid from multiple machining fluid supplies of the fluid distribution system to produce a single, mixed machining fluid for distribution through the manifold. For example, the fluid distribution system may be configured to mix a supercritical machining fluid from a first, supercritical machining fluid supply and a lubricant (i.e., non-supercritical machining fluid) from a second machining fluid supply to form a mixture that may be distributed through the manifold. Such a system may, advantageously, be able to take advantage of properties of both a supplied supercritical machining fluid and a supplied lubricant. Additionally or alternatively, a fluid distribution system may be configured to distribute machining fluid from different machining fluid supplies at different times, e.g., so that different machining fluids may be used with different machining tools. Such a system may, advantageously, allow for optimizing machining fluid use for cost or efficiency based on the unique demands of different machining tools that can be used in the machining system.

A fluid distribution system may comprise a fluid coupling configured to pass machining fluid from a machining fluid supply to the manifold. Any of a variety of appropriate fluid couplings may be used. For example, the fluid coupling may comprise a hose, channel, a pipe, or any of a variety of other suitable couplings. In some embodiments, the fluid coupling is configured for use with a supercritical machining fluid. In some embodiments, the fluid coupling is a flexible fluid coupling (e.g., a hose, tube, or other appropriate flexible coupling). The use of a flexible fluid coupling may be advantageous for certain fluid distribution systems comprising manifolds. For example, in some embodiments, a flexible fluid coupling can flex (e.g., bend or twist) to accommodate a change in manifold configuration (e.g., between a first, retracted configuration of the manifold, and a second, extended configuration of the manifold).

As noted above, one or more motion stages including one or more actuators may be used for changing the configuration of the manifold, or for controlling the position of the manifold with respect to the workpiece and/or the machining tool. In some embodiments, a fluid distribution system comprises one or more rotatable linkages connected to the manifold and an associated actuator. The one or more rotatable linkages be mechanically coupled to the manifold, such that rotation of the one or more rotatable linkages due to operation of the actuator may cause a change in the configuration of the manifold. For example, the one or more rotatable linkages may rotate and/or translate the manifold between the first, retracted configuration of the manifold and the second, extended configuration of the manifold. In some embodiments, the fluid distribution system comprises a plurality of motion stages which may provide at least two degrees of freedom for controlling movement of the manifold including lateral and longitudinal positioning of the manifold relative to an associated machining tool as elaborated on further below. Of course it should be understood that any appropriate type of motion stage including linear actuators, rotatable actuators, linear transmissions, rotatable linkages, combinations of the forgoing, and/or any other type of motion stage operatively coupled to the manifold. Rotatable linkages are described in greater detail with reference to the figures below.

The rotatable linkages may change the horizontal and/or vertical position of the manifold when actuated by one or more actuators. The one or more actuators of the fluid distribution system may be configured to rotate one or more rotatable linkages. In some embodiments, the one or more actuators are operatively coupled to a single rotatable linkage. According to some embodiments, the one or more actuators is a plurality of actuators that is configured to operate a plurality of rotatable linkages including multiple rotatable linkages arranged in an overall linkage arrangement, wherein controlling the two or more actuators may control both a horizontal and a vertical position of the manifold. In some embodiments, however, a plurality of rotatable linkages is configured to be operated by a single mechanical actuator of the fluidic system, and the rotatable linkages are mechanically coupled to one another in an appropriate arrangement to provide the desired motion. However, embodiments in which the manifold is moved through a linear translation using a linear actuator and/or linear transmission are also contemplated.

In addition to providing lateral movement of a manifold relative to a desired machine tool longitudinal axis, in some embodiments, a fluid distribution system may comprise a separate vertical motion stage. A motion stage may be configured to move the manifold parallel to an axis of a machining tool positioned for use within the system. For example, the vertical motion stage may be mechanically coupled to the manifold such that actuation of the motion actuation stage linearly translates the mechanical actuator in a vertical direction (e.g., which may lie substantially parallel to an axis of a machining tool). According to some embodiments, the fluid distribution system comprises a rotatable linkage configured to change the configuration of the actuator between the first, retracted configuration and the second, extended configuration, and further comprises a vertical actuation stage configured to adjust a vertical position of the manifold. Of course different arrangements using rotatable linkages, actuators, linear actuators, lead screws, linear transmissions, and/or any other appropriate type of motion stage capable of moving a manifold in a direction that is parallel to a longitudinal axis of a machining tool when positioned in a system may be used to appropriately position manifold along a longitudinal length of the machining tool.

A manifold or fluid distribution system described herein may be suitable for use with any of a variety of types of machining tools. In some embodiments, for example, the machining tool is a cutting tool. A few, non-limiting examples of machining tools that may be used are: milling systems, lathes, drills (e.g., hand-held or robotic drills), computer numerical control (CNC) systems implementing the above, and/or any other appropriate type of machining system where it may be desirable to provide a machining fluid to a machining interface with a part. In some aspects, the disclosure is directed towards machining systems that include a plurality of machining tools where the machining tools may be switched between different operations.

A tool for a machining system may include a tool body extending from a proximal end portion of the tool configured to be received in a tool holder to a distal end of the tool. A tool holder for a machining system includes a tool holder body including a tool receiving region at a first end portion and an attachment interface at a second end portion opposite the first end portion. The tool receiving region is constructed and arranged to receive a tool and secure the tool to the tool holder body. The attachment interface is constructed and arranged to secure the tool holder to a machining system. The tool holder may be configured to be rotated during a machining process (e.g., such that a tool secured in the tool holder rotates during machining). In some embodiments, the machining system comprises a spindle constructed and arranged to receive the tool holder.

The machining system may include exactly one tool holder or may include more than one tool holder, as the disclosure is not so limited. In some embodiments, tool changing in a machining system comprising multiple tool holders may comprise removing a first tool holder from a machining position (e.g., holding a first machining tool) and moving a second tool holder (e.g., holding a second machining tool) to a machining position as may occur during the switching between different tools in a CNC machine during different portions of a machining process of a part. However, in some embodiments, removing a first tool holder and inserting a second tool holder during tool changing is unnecessary, and the tool change may be accomplished by removing a first machining tool from a first tool holder and inserting a second machining tool into the first tool holder. In some embodiments, the use of multiple tool holders in a machining system may increase a total number of machining tools that can be used in the machining system (e.g., by providing compatibility with different sizes or shapes of tools).

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

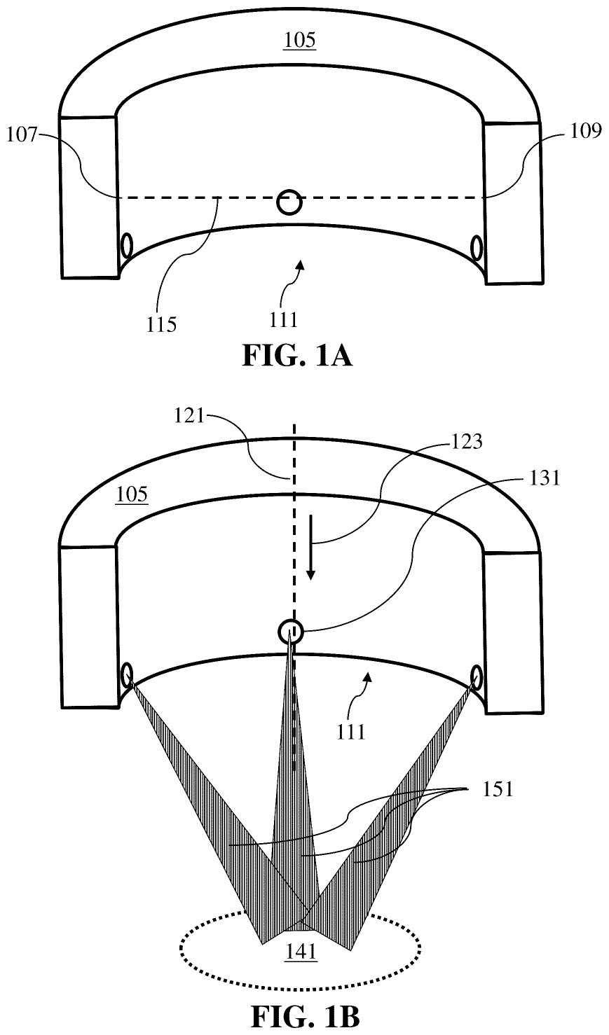

FIGS. 1A-1B present schematic, perspective illustrations of a manifold 105, according to some embodiments. The manifold includes a body that extends partially around an interior opening 111. As shown in FIG. 1A, the manifold body defines a portion of the boundary of the interior opening are (e.g., the curved portion of interior opening 111) and other portions of the boundary of the interior opening are open (e.g., the flat top, bottom, and side portions of interior opening 111). The interior opening may extend from a first surface of the manifold to a second surface of the manifold. For example, interior opening 111 of FIG. 1A extends from first surface 107 of manifold 105 to second surface 109 of manifold 105 that is located opposite from the first surface such that a line segment 115 between first surface 107 and second surface 109 passes through interior opening 111. The interior opening may extend from a first upper surface to a second bottom surface opposite from the first upper surface such that the manifold body extends partially around the interior opening. While a curved manifold body and curved interior opening are illustrated, it should be understood that other manifold body shapes may be used as elaborated on further below.

As noted previously, the manifold may be configured to cool a machining tool by directing one or more flows of supercritical machining fluid towards a machining interface. Thus, in some embodiments, the interior opening 111 of the manifold may be configured to accept a machining tool (e.g., may be appropriately sized and shaped to permit at least a portion of the machining tool to pass through the interior opening). Further, manifold 105 may include a gap (e.g., the gap defined by the flat, rectangular side portion of interior opening 111) formed on a portion of the manifold body through which a machining tool may pass in a lateral direction to pass from an exterior of the manifold into the interior opening 111 of the manifold. The gap may extend from the first upper surface of the manifold body to the second bottom surface of the manifold body in some embodiments.

The manifold may have a longitudinal axis that is perpendicular to two orthogonal lateral dimensions of the manifold. In some embodiments, the manifold is configured to at least partially surround a machining tool in a plane defined by the lateral dimensions. The manifold may be configured such that the machining tool extends in a direction that is substantially parallel to the longitudinal axis of the manifold when the manifold is in the extended configuration with the machining tool positioned in the interior opening of the manifold (e.g., the machining tool extends in a direction within less than or equal to 20°, less than or equal to 10°, less than or equal to 5°, less than or equal to 2°, or less than or equal to 1° of a direction of the longitudinal axis of the manifold).

The nozzles of the manifold may be oriented at least partially in a downstream direction parallel to the longitudinal axis of the manifold when the manifold is in the extended configuration. For example, FIG. 1B provides a schematic, perspective illustration of manifold 105, and shows longitudinal axis 121 and downstream direction 123 of manifold 105. As shown, nozzles 131 of manifold 105 are configured to emit machining fluid 151 (e.g., which may be a supercritical machining fluid or an expanded supercritical machining fluid) in directions that are at least partially oriented in the downstream direction 123 towards machining interface 141 (for visual clarity, a cutting tool that would define machining interface 141 is not shown). As shown, downstream direction 123 is not necessarily parallel to the direction of machining fluid 151 emitted from the nozzles 131, and the machining fluid may be emitted in a direction that is at least partially lateral with respect to the manifold (e.g., oriented radially inwards towards the machining tool and/or machining interface from a corresponding position on the manifold body). However, other appropriate orientations of the streams of machining fluid in different directions and/or arrangements are also contemplated.

In some embodiments, the manifold is configured such that the machining tool can pass laterally (e.g., in a direction perpendicular to an axis of rotation of the tool) into the interior portion. For example, the gap may be sized and shaped such that a machining tool can laterally pass into the interior portion of manifold 105 as the manifold is moved between an extended and retracted configuration. Such a manifold configuration may be advantageous for rapidly changing configuration of the manifold between the extended configuration of the manifold and the retracted configuration of the manifold (e.g., because removing the machining tool from the interior portion does not require the manifold to traverse the entire length of the machining tool when the machining tool passes laterally through the gap).

One or more nozzles may be disposed on the manifold. For example, manifold 105 comprises nozzles 131 as shown in FIG. 1B. The nozzles may be disposed in any of a variety of appropriate locations on the surface of the manifold (e.g., on the bottom surface oriented towards a machining interface and/or a side surface of the manifold disposed between an upper surface and bottom surface of the manifold opposite from the upper surface). Any of a variety of appropriate numbers of nozzles may be used. In some embodiments, greater than or equal to 1, greater than or equal to 2, greater than or equal to 3, greater than or equal to 4, greater than or equal to 5, greater than or equal to 8, greater than or equal to 10, greater than or equal to 15 or more nozzles are disposed on the manifold. In some embodiments, less than or equal to 20, less than or equal to 15, less than or equal to 10, less than or equal to 8, less than or equal to 5, less than or equal to 4, less than or equal to 3, less than or equal to 2 nozzles are disposed on the manifold. Combinations of these ranges are possible. For example, in some embodiments, greater than or equal to 1 and less than or equal to 20 nozzles are disposed on the manifold. Other ranges, both higher and lower than those described above, are also possible, as the disclosure is not so limited.

The one or more nozzles may be configured to direct a stream of machining fluid (e.g., supercritical machining fluid) towards a machining interface of a workpiece and/or towards a machining tool. For example, the one or more nozzles may be configured such that, when the manifold at least partially surrounds a machining tool, the nozzles direct machining fluid towards the cutting tool and/or towards a machining interface formed by an interaction of the machining tool with a workpiece. Some or all of the nozzles may be configured to emit supercritical machining fluid in a downstream direction of the manifold, as discussed above. The nozzles may also be distributed around a perimeter of the interior opening such that the separate streams of machining fluid may be directed towards the machining interface and/or machining tool from different orientations to provide improved coverage and lubrication of the machining interface and/or tool. Such a configuration may, advantageously, ensure that machining fluid is appropriately directed towards a workpiece when the machining system and fluid distribution system are in use. However, embodiments where one or more nozzles direct machining fluid in a non-downstream direction (e.g., in a purely lateral direction towards the machining tool) in order to lubricate the machining tool are also contemplated, as the disclosure is not so limited.

The manifold may extend partway around the interior opening in a lateral plane of the manifold. In some embodiments, the manifold extends greater than or equal to 10%, greater than or equal to 25%, greater than or equal to 50%, greater than or equal to 75% or more of the way around a perimeter of the interior opening. In some embodiments, the manifold extends less than or equal to 95%, less than or equal to 90%, less than or equal to 75%, less than or equal to 50%, less than or equal to 25%, or less of the way around the interior opening. Combinations of these ranges are possible. For example, in some embodiments, a manifold body may extends greater than or equal to 10% and less than or equal to 95% of the way around the perimeter of an interior opening with the remaining portion of the perimeter of the interior opening corresponding to a gap formed in the manifold body. In some embodiments, this percentage may be between or equal to 50% and 95%. Other ranges, both higher and lower than those described above, are also possible, as the disclosure is not so limited. As discussed above, it is also possible for the manifold to be used in a retracted configuration wherein it extends 0% of the way around a perimeter of the interior opening, in some embodiments. Of course, embodiments in which a manifold does not extend partially around a tool when positioned in an extended configuration (i.e., when a manifold is positioned adjacent to the tool or tool holder) are also contemplated.

The manifold may have any of a variety of appropriate geometries. In some embodiments, the manifold comprises a curved shape extending around a perimeter of the interior opening of the manifold. For example, the manifold may have a shape that is curved to extend laterally around the opening. In some embodiments, a manifold is curved such that it has the shape of a circular arc, or such that has a horseshoe or C-shape. For example, manifold 105 of FIGS. 1A-1B has a curved, C-shape that extends laterally around interior opening 111. In some embodiments, the manifold is not curved. For example, the manifold may have a polygonal shape and a polygonal interior opening. In some embodiments, a manifold may have a partially curved and partially-straight shape. For example, the manifold may have a U-shape, wherein the manifold is straight at each end and curved in the middle. Thus, it should be understood that a manifold body and interior opening may have any appropriate shape including, but not limited to, curved, C shaped, U shaped, polygonal, ovoid, circular, semi-circular, combinations of the forgoing, and/or any appropriate shape as the disclosure is not limited in this fashion.

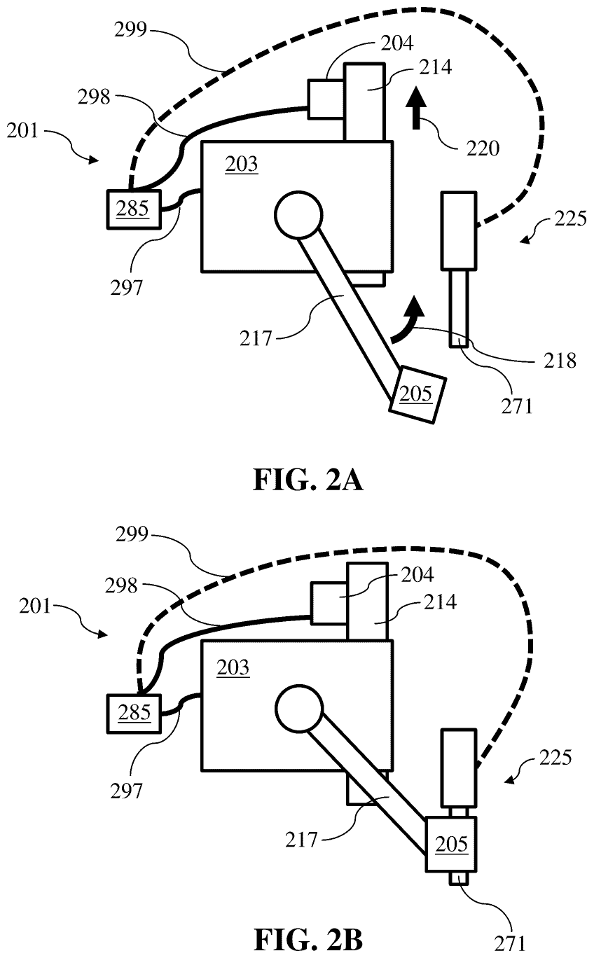

FIGS. 2A-2B present schematic, side-view illustrations of a portion of a non-limiting fluid distribution system 201 and a portion of a non-limiting machining system 225, to which the fluid distribution is configured to distribute fluid. FIG. 2A shows fluid distribution system 201 in a retracted configuration, where manifold 205 is spaced apart from and does not surround machining tool 271. In addition to manifold 205, fluid distribution system 201 comprises rotatable linkage 217, or other appropriate motion stage, which can move the manifold between a retracted and extended configuration using any appropriate movement, including rotation as indicated by curved arrow 218. FIG. 2B shows the same portions of fluid distribution system 201 and machining system 225, wherein manifold 205 is in the extended configuration with the machining tool positioned at least partially within and passing through an interior opening (not depicted) of the machining tool 271. This may include passing the machining tool through a gap formed in the manifold body as the manifold is moved at least partially in a lateral direction relative to a longitudinal axis, or other axis of movement, of the machining system.

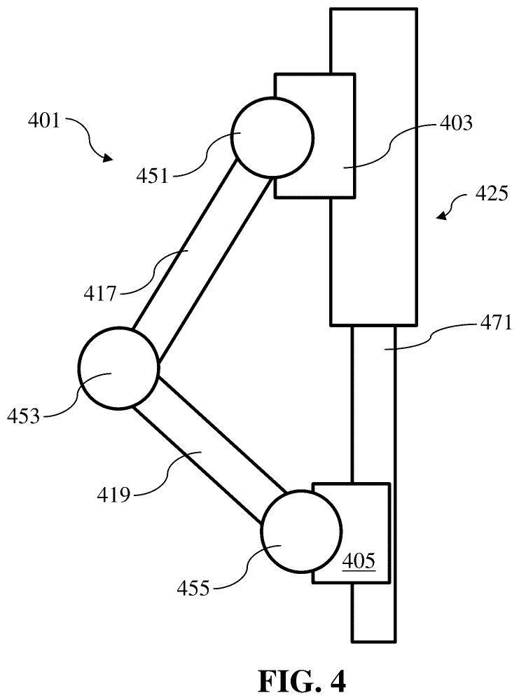

It should, of course, be understood that changing the configuration of the manifold may be accomplished using any appropriate motion stage or combination of motion stages to provide the desired movement. For example, the fluid distribution system could comprise a plurality of rotatable linkages. The plurality of rotatable linkages may include rotatable linkages that rotate independently and/or rotatable linkages that are mechanically coupled such that they rotate together. Examples of such rotatable linkages are provided in greater detail with reference to FIG. 4, below.

As shown in FIG. 2A, rotatable linkage 217 links manifold 205 to an actuator 203. The actuator may be configured to change a vertical and/or a horizontal position of the manifold. For example, actuator 203 is configured to move manifold 205 in an arc, thereby simultaneously changing the vertical and horizontal position of manifold 205 relative to the longitudinal axis of the machining tool. Any of a variety of suitable actuators may be used. For example, actuator 203 may be a motor configured to rotate the rotatable linkage. Any of a variety of suitable motors may be used as actuators. For example, the motor may be a shunt motor, a reluctance motor, a stepper motor, an AC motor, a universal motor, a servo motor, a DC motor (e.g., a permanent magnet DC motor (PMDC)), or a compound motor. The actuator may be mechanically coupled to the rotatable linkage by any of a variety of suitable transmissions, as the disclosure is not so limited.

As shown in FIGS. 2A-2B, the fluid distribution system may further comprise a vertical motion stage 214 configured to move the manifold in a vertical direction 220 parallel to a longitudinal axis of the machining tool when the manifold is in the extended configuration. Use of a motion actuation stage may be advantageous for any of a variety of reasons. For example, in some embodiments, the depicted motion stage advantageously permits adjustments to a manifold position along a length of a machining tool and/or the vertical position of the manifold relative to a machining interface when the manifold is in the extended configuration. These adjustments in the vertical position of the manifold may provide increased control over the location of the focus point of the separate streams of machining fluid that are configured to be emitted from a manifold during operation relative to a machining interface to be lubricated and/or cooled during operation.

The vertical motion stage may be configured to produce vertical motion in any of a variety of appropriate ways, as the disclosure is not so limited. For example, in FIGS. 2A-2B, actuator 203 is mounted on a linear motion stage 214 operated by actuator 204. However, other configurations are also possible, as the disclosure is not so limited. For example, a linear actuator, a series of linkages with separate actuators at the separate joints, complex arrangements of linkages with multiple actuators, and/or any other appropriate type of motion stage disclosed herein capable of providing vertical motion of the manifold may be used as the disclosure is not so limited.

In some embodiments, the fluid distribution system may comprise a controller including one or more processors and associated non-transitory computer readable memory that when executed cause the actuators, valves, pumps, and/or other portions of a fluid distribution system to perform any of the methods disclosed herein. For example, fluid distribution system 201 comprises controller 285 operatively coupled to actuator 203 by connection 297, such that one or more processors of controller 285 can actuate actuator 203, thereby changing the configuration of manifold 205 between the retracted configuration of FIG. 2A and the extended configuration of FIG. 2B. Similarly, as shown in FIGS. 2A-2B, controller 285 may be configured to actuate actuator 204 by connection 298 in order to control the vertical motion stage to change the vertical position of manifold 205. Optionally, controller 285 may be used to control machining system 225 as indicated by dashed connection 299. In some embodiments, the controller may be configured to control fluid distribution within the fluid distribution system. For example, the controller may actuate a valve connecting a machining fluid supply and the manifold, thereby selectively permitting or prevent a flow of machining fluid from the nozzles of the manifold.

In some embodiments, the fluid distribution system is configured to move the manifold close to the machining interface when the manifold is in the extended configuration. For example, in FIG. 2B, fluid distribution system 201 may be configured to maintain a predetermined distance between the nozzles of manifold 205 and a machining interface machining of the machining tool 225 disposed in the interior opening of manifold 205. Proximity between the manifold and the machining interface may provide any of a number of advantages, and may be particularly useful for distribution of supercritical machining fluids, where proximity to the machining tool reduces machining fluid loss and improves the machining process. In some embodiments, the predetermined distance between the machining interface and the nozzles of the manifold in the extended configuration is less than or equal to 10 cm, less than or equal to 7.5 cm, less than or equal to 5 cm, less than or equal to 3 cm, less than or equal to 1 cm, less than or equal to 0.5 cm, or less. In some embodiments, the predetermined distance between the machining interface and the nozzles of the manifold in the extended configuration is greater than or equal to 0.1 cm, greater than or equal to 0.5 cm, greater than or equal to 1 cm, greater than or equal to 3 cm, greater than or equal to 5 cm, greater than or equal to 7.5 cm, or greater. Combinations of these ranges are possible. For example, in some embodiments, the predetermined distance between the machining interface and the nozzles of the manifold in the extended configuration is greater than 0.1 cm and less than or equal to 10 cm. Other ranges, both higher and lower than those described above, are also possible, as the disclosure is not so limited.

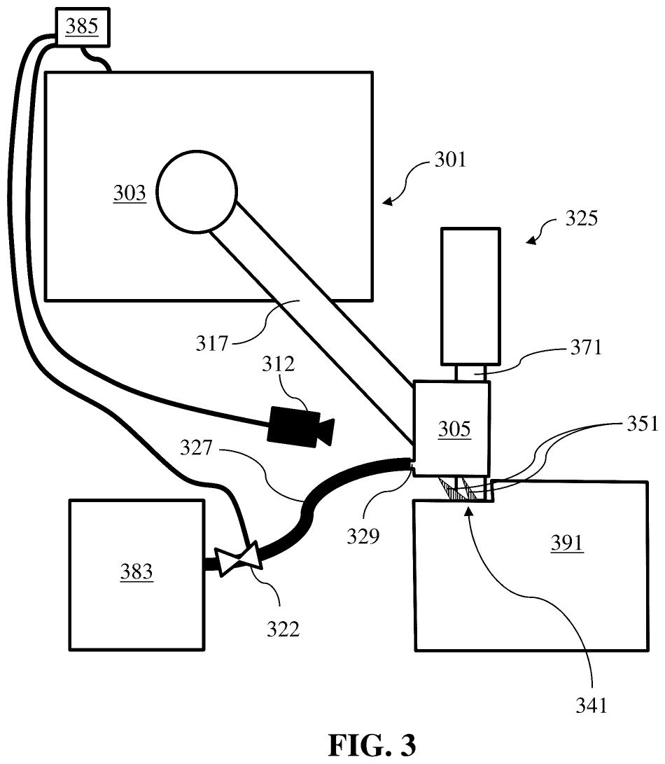

FIG. 3 shows a schematic, side-view illustration of a portion of a fluid distribution system 301 distributing machining fluid 351 to a portion of machining system 325 at machining interface 341 of workpiece 391. Fluid distribution system 301 is similar to fluid distribution 201 described with reference to FIGS. 2A-2B. As shown in FIG. 3, fluid distribution system 301 may supply machining fluid 351 (e.g., supercritical machining fluid) to the machining interface and/or machining tool 371 of machining system 325 using manifold 305. Manifold 305 may be mechanically coupled to one or more actuator 303 by a rotatable linkage 317 or other appropriate motion stage. Additionally, fluid distribution system 301 may comprise a controller 385 configured to control operation of the various components of the illustrated system.

Also shown in FIG. 3 manifold 305 may include an inlet 329 according to some embodiments. Any of a variety of suitable inlets may be used for the manifold. For example, the inlet may be a supercritical machining fluid inlet, and/or may comprise fittings or couplings suitable for passing a supercritical fluid into manifold 305 without leakage or pressure loss. Thus, in some embodiments, the inlet 329 is connected to machining fluid supply 383 by fluid coupling 327. During operation the machining fluid supply may be configured to deliver a supercritical machining fluid (e.g., scCO₂) to manifold 305. According to some embodiments the inlet is configured for conventional machining fluids (i.e., non-supercritical machining fluids). As shown in FIG. 3 controller 385 may also be operatively coupled to one or more valves 322 such that the controller may control (i.e., selectively permit or prevent) the flow of machining fluid to the one or more nozzles of the manifold as described previously. For example, the controller may control the flow of machining fluid to the one or more nozzles of the manifold in response to input from a sensor or from the machining tool.

Although only one fluid supply is shown in FIG. 3, it should of course be understood that in some embodiments, a plurality of fluid supplies may each, independently be used to supply fluid to the manifold. For example, the fluid distribution system may include a first, supercritical machining fluid supply and a second, non-supercritical machining fluid supply. The manifold may comprise multiple inlets configured to receive machining fluid independently from different machining fluid supplies. In some embodiments, the fluid distribution system is configured to pass machining fluid from more than one machining fluid supply to the manifold through the same inlet. For example, the fluid distribution system may be configured to pass machining fluid from different machining fluid supplies in sequence, or may pre-mix machining fluid from multiple machining fluid supplies to form a mixed machining fluid before passing the mixed machining fluid through the inlet. Fluid flow from a plurality of machining fluid supplies may be controlled independently by a controller, For example, each machining fluid supply may be controlled using an independent valve like valve 322. In some embodiments, valve 322 may be a multi-way valve (e.g., a 3-way valve, a 4-way valve) that fluidically connects manifold 305 to a plurality of machining fluid supplies to selectively control the flow of fluid from each of the connected fluid supplies. It should, of course, be understood that although valve 322 is shown as integrated into fluid coupling 327, valves may generally be included in any of a variety of appropriate locations within the fluid distribution system at any point along a flow path extending between a machining fluid supply 383 or manifold 305 as the disclosure is not so limited.

In some embodiments, such as the embodiment of FIG. 3, the fluid distribution system comprises a sensor. The sensor may be configured to sense a machining interface location. Alternatively, the sensor may sense or otherwise obtain a length of a tool that is positioned within a machining system, or will be positioned within the machining system, to determine a location of a machining interface based on the length of the tool to be used during a machining process. For example, in one embodiment fluid distribution system 301 comprises sensor 312, which is configured to determine the location and/or a property of a machining interface 341 optically and/or in any other manner. In general, any of a variety of sensors may be used. Thus, in some embodiments, the sensor may be an optical sensor (e.g., a camera) configured to directly measure the length of the cutting tool and/or the position of the interface. In other embodiments, the sensor may be configured to obtain a length of the detect the tool by detecting a label of a machining tool. For example, sensor 312 may be a Radio Frequency Identification (RFID) sensor configured to detect an RFID tag of the machining tool. Positive identification of a tool having known dimensions may be used to obtain a tool length or a position of a machining interface. According to yet other embodiments, the sensor is a position sensor or a proximity sensor (e.g., a laser sensor or infrared distance sensor) that is configured to measure a distance between a known location on a system and a machining interface. Other appropriate sensors may include, but are not limited to, pyrometers, thermocouples, distance sensors (e.g., LIDAR, ultrasonic sensors, RFtoF sensors), sensors of the machining system (e.g., torque sensors, draw sensors, vibration sensors, or acoustic emission sensors), inductance/capacitance sensors, or phase shift sensors, and/or any other appropriate type of sensor capable of sensing a location and/or a property of a machining interface or other appropriate portion of a part. Alternatively, the machining interface location and/or tool length may be known due to a commanded tool to be used in an automated system. Thus, it should be understood, that in one way or another a machine tool length and/or a position of a machining interface may be obtained either using sensor 312 or another appropriate method for providing to controller 385, as shown in FIG. 3. The controller may the control operation of the system to appropriately position the manifold relative to the machining interface during operation based at least in part on this information.

In some embodiments, the sensor is a temperature sensor. The temperature sensor may be a thermocouple or other thermometer (e.g., an optical thermometer). In some embodiments, the temperature sensor is inside a workpiece or a machining tool. According to some embodiments, the temperature sensor is configured to sense temperature remotely. The temperature sensor may be a thermal imaging system configured to image a spatial temperature distribution (e.g., of the machining interface and/or of the machining tool). According to some embodiments, the sensor is configured to detect a local temperature. For example, a thermocouple or thermometer may be configured to detect a local temperature. Likewise, a thermal imaging system may be configured to measure a local temperature, e.g., within a pre-defined location of interest, or by identifying and determining the temperature of whatever location of the machining interface has the maximum temperature of the machining interface.

The sensor may be a sensor configured to determine a machining fluid property at a machining interface. For example, the sensor may be a camera configured to visually identify an extent of expansion of the supercritical fluid after the supercritical fluid flows from the nozzle. In some embodiments, the sensor is a temperature sensor and/or a pressure sensor configured to identify a temperature and/or a pressure of the machining fluid proximate to the machining interface. In some embodiments, the sensor is configured to detect a concentration of dry ice in the expanded supercritical fluid.

In some embodiments, the sensor is configured to determine a cut angle or a cut intensity of the machining tool at the machining interface. For example, a cut angle may be determined by visual inspection, LIDAR, contact sensing, acoustic emission and/or vibration analysis. In some embodiments, a cut intensity is determined using a force sensor (e.g., a dynamometer) and/or a power sensor (e.g., a sensor configured to determine the horsepower of the machining tool), or vibration analysis. According to some embodiments, the sensor is configured to measure the condition (e., the size, the shape) of chips removed from a workpiece.

The sensor may have any of a variety of appropriate dispositions with respect to the fluid distribution system, the machining system, and/or the workpiece. For example, the sensor could be mounted to the fluid distribution system, the machining system, or the workpiece. In some embodiments, the sensor is free-standing. For example, the sensor may be affixed to a stand or mount. The sensor may be configured to maintain a fixed position during machining, according to some embodiments. In some embodiments, the sensor is configured to be moved during machining (e.g., to clear a path for a tool change operation).

It should, of course, further be understood that while a single sensor is illustrated in the above embodiment, more than one sensor may be used, depending on the embodiment. For example, in some embodiments a position sensor may be combined with an RFID reader, e.g., to obtain both pre-measured tool geometry (e.g., tool length) and a measured position of the sensor and/or of the tool relative to a machining interface during operation.

As discussed above, in some embodiments, it is advantageous for manifold 305 to be positioned close to machining interface 341 when delivering machining fluid 351, particularly when machining fluid 351 comprises a supercritical machining fluid. However, it may also be advantageous to keep manifold 305 separated from machining interface 341 by a sufficient distance to avoid damage that could result from the machining process (e.g., damage that could result from the collision of machined material with the manifold or with nozzles disposed thereon). In some embodiments, the minimum distance between the machining interface and the manifold in the extended configuration is less than or equal to 50 cm, less than or equal to 25 cm, less than or equal to 10 cm, less than or equal to 7.5 cm, less than or equal to 5 cm, less than or equal to 3 cm, less than or equal to 1 cm, or less. In some embodiments, the minimum distance between the machining interface and the manifold in the extended configuration is greater than or equal to 0.5 cm, greater than or equal to 1 cm, greater than or equal to 3 cm, greater than or equal to 5 cm, greater than or equal to 7.5 cm, greater than or equal to 10 cm, greater than or equal to 25 cm, or greater. Combinations of these ranges are possible. For example, in some embodiments, the minimum distance between the machining interface and the manifold in the extended configuration is greater than 0 cm and less than or equal to 50 cm. Other ranges, both higher and lower than those described above, are also possible, as the disclosure is not so limited.

Although the embodiments discussed in FIGS. 2A-2B and 3 present fluid distribution systems with only a single rotatable linkage, it should, of course, be understood that more than one rotatable linkage and/or different types of motion stages to provide the lateral and/or longitudinal (i.e., horizontal and/or vertical movement) may be used. FIG. 4 presents a schematic, side-view illustration of a portion of a non-limiting fluid distribution system 401 and a portion of a non-limiting machining system 425, to which the fluid distribution is configured to distribute fluid. Fluid distribution system 401 comprises two rotatable linkages, 417 and 419, connected via joint 453. Rotatable linkage 417 is also connected to actuator 403 via joint 451, and the fluid distribution system may be configured such that actuator 403 actuates joint 451 in order to rotate rotatable linkage 417. According to some embodiments, actuator 403 may also be configured to actuate joint 453, rotating rotatable linkage 419. In some embodiments, joint 453 is operatively coupled to joint 451 such joints 451 and 453 are actuated together (e.g., joints 451 and 453 may be operatively coupled such that rotatable linkage 417 is slaved to rotatable linkage 419). However, in some embodiments, joint 453 is configured to be actuated independently from joint 451. For example, actuator 403 could actuate joints 451 and 453 independently in some embodiments. According to some embodiments, a fluid distribution system comprises one or more additional actuators (not shown) configured to actuate rotation of joint 453 independently from actuation of joint 451 by actuator 403.

Rotatable linkage 419 is coupled to manifold 405 via joint 455, which is configured to rotate manifold 405. Like joint 453, in some embodiments joint 455 is configured to be actuated independently of joint 451. For example, joint 455 may be configured to be actuated by actuator 403 or by another actuator (not shown). According to some embodiments, joint 455 is operatively coupled to joint 451, such that actuation of joint 451 actuates joint 455. For example, manifold 405 could be slaved to rotatable linkage 419 and/or rotatable linkage 417, in some embodiments.

FIG. 4 presents fluid distribution system 401 in the extended configuration, wherein manifold 405 at least partially surrounds machining tool 471 of machining system 425. However, fluid distribution system 401 may be moved from the extended configuration to a retracted configuration by actuating joints 415, 453, and/or 455, such that rotatable linkages 417 and 419 rotate to withdraw manifold 405. One advantage of a fluid distribution system comprising multiple rotatable linkages is that, according to some embodiments, the rotatable linkages can be used to retract or extend the manifold of a portion of a fluid distribution system mounted on a machining system.

According to some embodiments, the use of multiple rotatable linkages provides certain advantages over the use of a single rotatable linkage. For example, in some embodiments, horizontal and vertical position of a manifold can be controlled independently using a plurality of rotatable linkages.

In a fluid distribution system comprising multiple rotatable linkages, some rotatable linkages may be actuated independently from other connected rotatable linkages which may help to provide complex combinations of horizontal and/or vertical motion of an associated end effector (i.e., the disclosed manifolds). In some embodiments, a flexible fluid coupling, not depicted, may be supported on and optionally extend along at least a portion of a length of one or more rotatable linkages of the fluid distribution system such that the flexible fluid coupling may be coupled to a manifold mounted on the depicted system. Flexible fluid couplings may be particularly advantageous in the context of fluid distribution systems such as fluid distribution system 401, since they can bend to accommodate changes in the relative positions of the rotatable linkages.

In some embodiments at least a portion of a fluid distribution system is configured to be mounted on a machining system. For example, FIG. 4 shows fluid distribution system 401 mounted on machining system 425 by actuator 403, which is rigidly coupled to machining system 425 such that actuator 403 maintains a fixed position relative to machining tool 471. Mounting some or all of the fluid distribution system onto the machining system may provide a number of advantages. For example, in some embodiments, mounting a portion of the fluid distribution system on the machining system may couple movements of the fluid distribution system to movements of the machining system, reducing the complexity of aligning the manifold of the fluid distribution system with a machining interface. However, coupling of the fluid distribution system to the machining system is not necessary, and separately mounted fluid distribution systems may be advantageous for other reasons. For example, unmounted fluid distribution systems may be used with existing machining systems, without requiring retrofitting of the existing machining systems to permit mounting of the fluid distribution system.

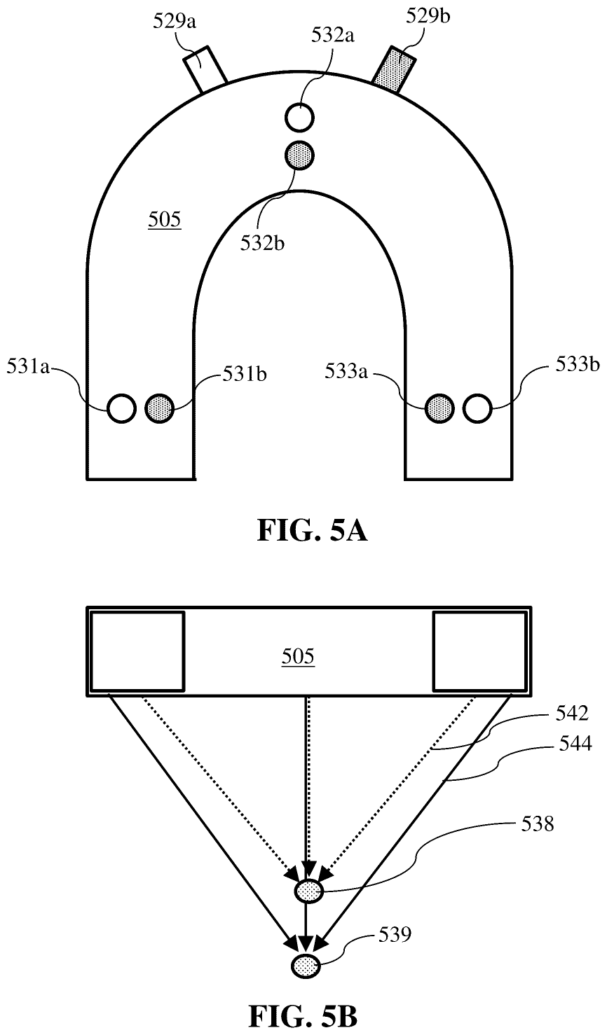

FIGS. 5A-5B provide non-limiting, schematic illustrations of manifold 505 on which nozzles 531a, 531b, 532a, 532b, 533a, and 533b are disposed. A plurality of nozzles disposed on a manifold may share a common focal location towards which all nozzles of the plurality are configured to emit machining fluid (e.g., supercritical machining fluid). However, as noted previously, and as illustrated in the figures, in some embodiments, a plurality of nozzles includes multiple groups of nozzles, wherein a first group of nozzles is directed towards a first focal location and a second group of nozzles is directed towards a second focal location. For example, FIG. 5A shows a bottom view schematic illustration of manifold 505, which includes first group of nozzles 531a, 532a, and 533a and second group of nozzles 531b, 532b, and 533b. Shading of the nozzles in FIG. 5A is used to distinguish nozzles of different groups. It should, of course, be understood that nozzles of different groups could be the same or different types of nozzles, and that the shading does not indicate any particular type of nozzle. FIG. 5B shows a side view schematic illustration of manifold 505, illustrating how machining fluid may be directed from the first group of nozzles towards a first focal location 539 during operation (the direction of flow from the first nozzle group is indicated by solid arrows 544) and from the second group of nozzles towards a second focal location 538 (the direction of flow from the second nozzle group is indicated by dashed arrows 542). The second focal location 538 is offset relative to the first focal location 538 in a direction parallel to a longitudinal axis of the interior opening and/or of a machining tool when the manifold is in the extended configuration with the machining tool positioned in the interior opening.

In FIG. 5A, first group of nozzles 531a, 532a, and 533a is not fluidically connected to second group of nozzles 531b, 532b, and 533b. In such an embodiment, the nozzles of the first group may be fluidically connected to a first inlet, which may admit the passage of machining fluid to the first group of nozzles, and the nozzles of the second group may be fluidically connected to a second inlet. For example, in FIG. 5A, first group of nozzles 531a, 532a, and 533a is fluidically connected to inlet 529a and second group of nozzles 531b, 532b, and 533b is fluidically connected to second inlet 529b. As with the shading of the nozzles themselves, the shading of the inlets is used to distinguish inlets based on their association with a particular nozzle group, rather than as an indication of a difference between inlet 529a and inlet 529b. Furthermore, it should be noted that manifolds including multiple nozzle groups do not necessarily require multiple inlets. For example, in some embodiments, the manifold includes a valve (e.g., a valve operatively linked to a controller) configured to control the flow of fluid from a single inlet of the manifold to one or more nozzle groups. Depending on the embodiment, and arrangement of one or more valves, the separate groups of nozzles may either be connected to separate fluid supplies or the same fluid supply. The use of multiple nozzle groups may provide a number of advantages. For example, in some embodiments, instead of adjusting a vertical position of the manifold to change a focal position of the separate streams of machining fluid (e.g., following a tool change or following a change in the location of the machining interface), fluid may be rerouted from a first nozzle group oriented towards a first focal location to a second nozzle group oriented towards a second focal location having a vertical position differing from the vertical position of the first focal location. As another example, in some embodiments a first nozzle group may be configured to deliver a first machining fluid to a machining tool while a second nozzle group is configured to deliver a second machining fluid to the machining interface. Other advantageous configurations of nozzle groups are also possible, as the disclosure is not so limited.

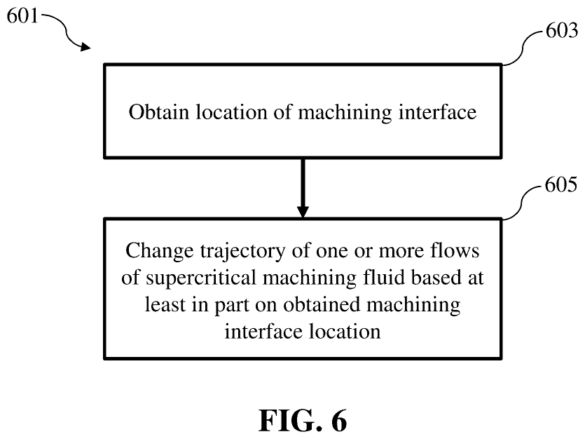

FIG. 6 provides a non-limiting, schematic illustration of a method of machining, according to some embodiments. Machining method 601 may be performed under any of a variety of circumstances during machining, but may be particularly useful to perform during tool changing. For example, method 601 may be a method of controlling a flow of supercritical machining fluid for better suitability with a replacement machining tool. However, the disclosure is not limited to such embodiments and method 601 may be used under other circumstances (e.g., during active machining) if desired.

Method 601 comprises a first step 603 of obtaining a location of the machining interface. The machining interface location may be determined in any of a variety of ways. For example, the machining interface location may be obtained using a sensor, a commanded tool change, or other appropriate method as described in greater detail above. In some embodiments, obtaining the location of the machining interface includes obtaining a length of a machining tool. For example, a machining tool's length may be obtained by identifying the machining tool (e.g., using an RFID reader) and using a pre-determined length of the machining tool to determine a corresponding location of a machining interface or other location to be lubricated. The pre-determined length of the machining tool could be retrieved from a database, for example, once the tool has been identified. As another example, a machining tool's length may be determined by sensing the tool's length (e.g., using an optical sensor configured to detect the machining tool's length). For example, in some embodiments, the machining tool's length is obtained using a proximity sensor or a camera system. In some embodiments, the length of the machining tool may be used to determine the machining interface location (e.g., by calculating the machining interface location based on the length of the machining tool). Alternatively, a machining interface location may be obtained directly. For example, in some embodiments, the method comprises directly sensing the location of the machining interface (e.g., using a camera system). According to some embodiments, the method comprises obtaining the machining interface location from a machining plan.

Method 601 further comprises the step 605 of changing the trajectory of one or more flows of supercritical machining fluid (e.g., flows emitted from one or more nozzles of a manifold) based, at least in part, on the machining interface location obtained in step 603. The trajectory of the supercritical machining fluid may be changed in any of a variety of appropriate ways described herein. For example, in some embodiments, changing the trajectory comprises moving at least a portion of a fluid distribution system (e.g., a manifold of a fluid distribution system) in a direction substantially parallel to a longitudinal axis of a machining tool. For example, changing the trajectory may comprise moving a manifold vertically to focus the supercritical machining fluid flows on the machining interface. The motion of the portion of the fluid distribution system (e.g., the motion of the manifold) may be performed using any of a variety of appropriate methods. For example, some or all of the fluid distribution system may be mounted to a vertical actuation stage, as described in greater detail above. As another example, a method may comprise changing an angular orientation of the one or more flows of supercritical machining fluid emitted from a manifold. The angular orientation of the one or more flows may be changed, for example, by flowing the supercritical machining fluid through a different nozzle group of a manifold, or by reorienting one or more nozzles of the manifold to focus on a different focal location. This may be done as elaborated on further above using one or more associated valves to selectively permit or prevent the flow of machining fluid to the different groups of nozzles. One advantage of the systems and methods described herein is that they may facilitate rapid tool changes in a machining system during a machining process.

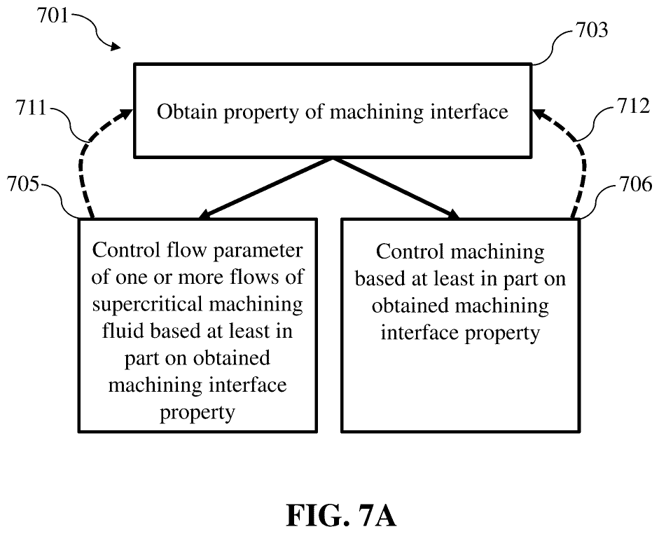

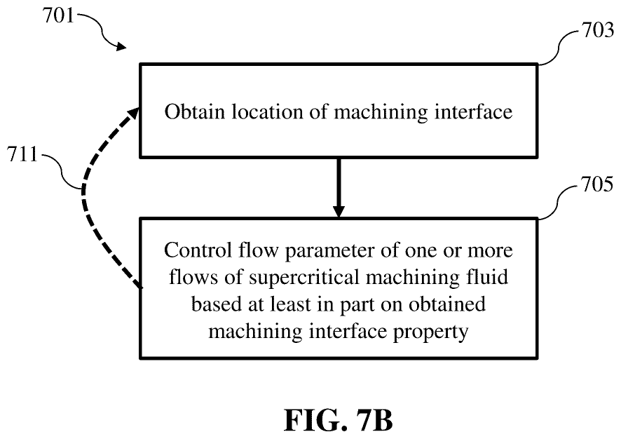

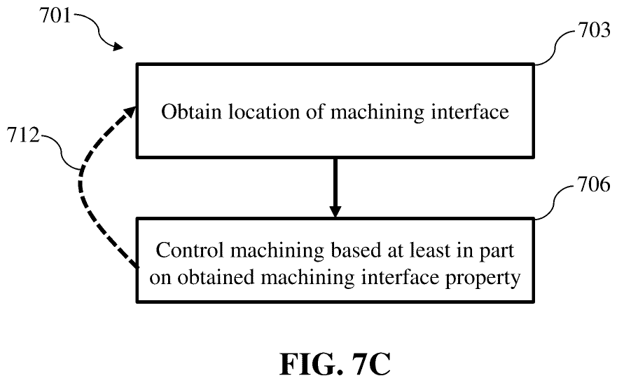

FIG. 7A provides a non-limiting, schematic illustration of a method of machining, according to some embodiments. Machining method 701 may be performed under any of a variety of circumstances during machining, but may be particularly useful to perform during active machining. For example, method 701 may facilitate improved control of workpiece temperature and/or machining fluid flow that reduces the risk of thermal damage to the workpiece, that improves lubricity of the workpiece, that improves cooling of the workpiece, and/or that reduces the amount of machining fluid used during machining. However, the disclosure is not limited to such embodiments and method 601 may be used under other circumstances (e.g., at times other than during active machining) if desired.

Method 701 comprises a first step 703 of obtaining a property of the machining interface. The property of the machining interface could be a location of the machining interface as described with reference to FIG. 6 above. According to some embodiments, the property of the machining interface is a thermal property of the machining interface (e.g., a temperature of the machining interface or a spatial temperature distribution of the machining interface). In some embodiments, the property of the machining interface is a property of the machining fluid (e.g., the supercritical fluid) at the machining interface. According to some embodiments, the property of the machining interface is a cut direction (e.g., which may indicate which side of a cut would benefit most from additional machining fluid). In some embodiments, the property of the machining interface is a cut intensity (e.g., a force or stress imposed on the workpiece by the cutting tool).

The machining interface property may be determined in any of a variety of ways. For example, the machining interface location may be obtained using a sensor, a commanded tool change, or other appropriate method as described in greater detail above. As another example, thermal properties of the machining interface such as average temperature, local temperature, or spatial temperature distribution may be determined using a sensor as described in greater detail above. Likewise, machining interface properties related to the properties of the machining fluid at the machining interface may be determined using a sensor as described in greater detail above. Similarly machining interface properties such as cut direction may be determined using a sensor as discussed in greater detail above and/or the interface properties may correspond to commanded properties implemented by the system during a machining process. For example, the commanded tool path during machining of the part may be used in some embodiments.

Method 701 further comprises step 705 of changing a flow parameter of one or more flows of supercritical machining fluid (e.g., flows emitted from one or more nozzles of a manifold) and step 706 of changing a machining speed of a machining tool contacting one or more flows of supercritical machining fluid. Method 701 comprises performing one or both of steps 705 and 706 based, at least in part, on the machining interface property obtained in step 703.

The flow properties of the supercritical machining fluid may be changed in any of a variety of appropriate ways described herein. For example, the trajectory of the supercritical machining fluid may be changed as discussed above. As another example, a flow rate of the supercritical machining fluid may be changed by any of a variety of appropriate methods. For example, a pressure of the supercritical machining fluid may be changed. As another example, a valve upstream of the manifold may be actuated to control a flow rate of the supercritical machining fluid. Likewise, the machining speed may be changed in any of a variety of appropriate manners. For example, a rotation speed of a machining tool may be changed. As another example, a feed rate of a machining tool relative to a machining interface of a workpiece may be changed. In some embodiments, the machining speed may be changed by reducing machining speed to zero, e.g., as part of a tool change. Thus, the obtained machining interface property may be used to determine whether a machining tool has become inappropriate or should be exchanged for another tool as part of a machining process. Other embodiments are also possible, as the disclosure is not so limited.

Method 701 may be performed as part of a closed-loop method, whereby machining interface properties are iteratively obtained and used as the basis for refinements of a machining process. For example, method 701 may be part of a method comprising multiple repetitions of step 703 and either or both of steps 705 and 706. FIG. 7A indicates the possibility of the use of method 701 as part of a closed-loop method by dashed arrows 711 and 712, indicating the optional repetition of step 703 following the performance of either step 705 or step 706. The optional repetition of step 703 and either or both of steps 705 and 706 may be performed continuously during active machining, or may be used discontinuously (e.g., may be toggled by a user) during active machining.

In some embodiments, method 701 is used to control a fluid distribution system (e.g., to perform a closed-loop method of machining using the fluid distribution system). For example, FIG. 7B illustrates an embodiment of method 701, wherein step 705 of controlling a flow parameter of one or more flows of supercritical fluid is necessarily performed. Using method 701 as shown in FIG. 7B, a closed-loop method may be executed using a fluid distribution system. In some embodiments, method 701 is used to control a machining system (e.g., to perform a closed-loop method of machining using the machining system). For example, FIG. 7C illustrates an embodiment of method 701, wherein step 706 of controlling a flow parameter of one or more flows of supercritical fluid is necessarily performed. Using method 701 as shown in FIG. 7C, a closed-loop method may be executed using a machining system. Of course, FIGS. 7B-7C should not be understood to limit method 701 and, as illustrated in FIG. 7A, method 701 may be used to control both a fluid distribution system and a machining system. For example, a closed-loop method may be used to control both a fluid distribution system and a machining system as part of a closed-loop machining method involving both systems. As another example, independent closed-loop methods as shown in FIGS. 7B and 7C could simultaneously and independently be used to control machining and/or flow parameters of flows of supercritical machining fluid.

In some embodiments, the above noted methods are implemented by one or more processors associated with non-transitory computer readable memory including processor executable instructions that when implemented by the one or processors cause a system to perform the above disclosed methods.

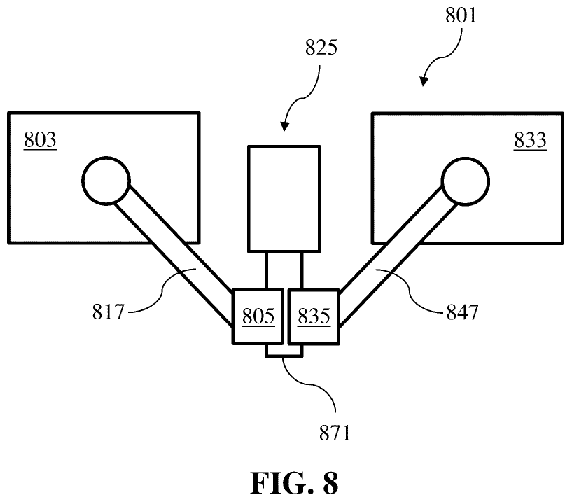

Although the figures above illustrate the use of a single manifold, it should of course be understood that in some embodiments more than one manifold may be used. For example, FIG. 8 presents a schematic side-view illustration of a portion of a non-limiting fluid distribution system 801 comprising multiple manifolds and a portion of a non-limiting machining system 825, to which the fluid distribution system is configured to distribute fluid. As shown, fluid distribution system 801 comprises first actuator 803 configured to change the configuration of first manifold 805 by rotating rotatable linkage 817 and second actuator 833 configured to change the configuration of first manifold 835 by rotating rotatable linkage 847. Manifolds 805 and 835 are each shown in the extended configuration, wherein they at least partially surround machining tool 871 of machining system 825—however, actuators 803 and 833 may be used to retract manifolds 805 and 835, respectively into extended configurations, in some embodiments. Although only two manifolds are shown in FIG. 8, it should of course be understood that any of a variety of suitable numbers of manifolds (e.g., 3, 4, 5, 6, or more manifolds) may be used in a fluid distribution system, depending on the embodiment, as the disclosure is not so limited. The use of more than one manifold may, advantageously, facilitate more well-distributed distribution of supercritical fluid without slowing tool changes, in some embodiments. Although FIG. 8 shows all manifolds of fluid distribution system 801 in use simultaneously, it should, of course, be understood that in some embodiments only a subset of the manifolds of the fluid distribution system are used. The use of multiple manifolds can thus be customized for particular machining tools. In some embodiments, for example, it may be advantageous to use two manifolds when machining with a first machining tool (e.g., a relatively large machining tool) and to use only one manifold when machining with a second machining tool (e.g., a relatively small machining tool).

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A fluid distribution system comprising:
a manifold partially surrounding an interior opening of the manifold, wherein the interior opening extends from a first surface of the manifold to a second opposing surface of the manifold, wherein the interior opening is configured to accept a machining tool positioned therein, and wherein the manifold includes a gap through which the machining tool may laterally pass into the interior opening of the manifold in a direction that is at least partially perpendicular to a longitudinal axis of the interior opening;
one or more actuators configured to move the manifold between a first retracted configuration and a second extended configuration;
one or more nozzles disposed on the manifold; a machining fluid inlet of the manifold in fluid communication with the one or more nozzles; and
a vertical motion stage configured to change a vertical position of the manifold.

2. The fluid distribution system of claim 1, wherein the vertical motion stage is configured to change the vertical position of the manifold while the manifold is in the retracted position.

3. A fluid distribution system comprising:
a manifold partially surrounding an interior opening of the manifold, wherein the interior opening extends from a first surface of the manifold to a second opposing surface of the manifold, wherein the interior opening is configured to accept a machining tool positioned therein;
one or more nozzles disposed on the manifold; and
a machining fluid inlet of the manifold in fluid communication with the one or more nozzles,
wherein the one or more nozzles comprise a plurality of nozzles that includes a first group of nozzles directed towards a first focal location and a second group of nozzles directed towards a second focal location different from the first focal location.

4. The fluid distribution system of claim 3, wherein the manifold includes a gap through which the machining tool may laterally pass into the interior opening of the manifold in a direction that is at least partially perpendicular to a longitudinal axis of the interior opening.

5. The fluid distribution system of claim 3, further comprising one or more actuators configured to move the manifold between a first retracted configuration and a second extended configuration.

6. The fluid distribution system of claim 1, wherein the one or more nozzles are configured to be directed towards a machining interface of the machining tool when the machining tool is positioned in the interior opening.

7. The fluid distribution system of claim 3, further comprising one or more valves configured to selectively control a flow of machining fluid to the first group of nozzles and the second group of nozzles.

8. The fluid distribution system of claim 1, wherein the manifold has a curved shape extending around the perimeter of the opening.

9. The fluid distribution system of claim 1, further comprising a separate actuator configured to actuate the vertical motion stage.

10. The fluid distribution system of claim 1, further comprising one or more rotatable linkages connected to the manifold and the one or more actuators.

11. The fluid distribution system of claim 1, wherein the fluid distribution system is constructed and arranged such that when the manifold moves from the first retracted configuration to the second extended configuration, the machining tool laterally passes through the gap.

12. The fluid distribution system of claim 1, wherein the manifold is configured to at least partially surround the machining tool when the manifold is in the second extended configuration.

13. A machining system, comprising:
the fluid distribution system of claim 1; and
one or more tool holders, including a first tool holder configured to hold the machining tool.

14. The machining system of claim 13, further comprising a supercritical machining fluid supply, configured to provide supercritical machining fluid to the machining fluid inlet.

15. The fluid distribution system of claim 1, further comprising a fluid coupling fluidically connecting the manifold to the supercritical machining fluid supply.

16. The fluid distribution system of claim 1, wherein the fluid coupling is a flexible fluid coupling.

17. The machining system of claim 14, wherein the supercritical machining fluid supply is a first machining fluid supply, and wherein the fluid distribution system further comprises a second machining fluid supply constructed and arranged to deliver a second machining fluid to the machining fluid inlet.

18. The machining system of claim 17, wherein the second machining fluid is a non-supercritical machining fluid.

19. The machining system of claim 13, wherein the machining tool is a first machining tool, and wherein the machining system comprises a plurality of machining tools including the first machining tool.

20. The machining system of claim 19, wherein the machining system is configured to switch the first machining tool for a second machining tool of the plurality of machining tools while the manifold is in the first, retracted configuration.

21. The fluid distribution system of claim 1, wherein the manifold is configured to surround at least 50% of a cross sectional perimeter of the machining tool when the manifold is in the second, extended configuration.

22. The fluid distribution system of claim 1, wherein when the manifold is in the second, extended configuration, a distance between the manifold and the machining interface is less than or equal to 10 cm.

23. A method of machining, the method comprising:
moving a manifold including one or more nozzles disposed thereon from a first retracted configuration spaced apart from a first machining tool towards a second extended configuration, wherein moving the manifold from the first retracted configuration towards the second extended configuration includes a lateral movement of the manifold relative to a longitudinal axis of the first machining tool;
passing the first machining tool through a gap formed in the manifold into an interior opening of the manifold as the manifold is moved from the first retracted configuration towards the second extended configuration such that the first machining tool extends through the interior opening of the manifold when the manifold is in the second extended configuration; and
moving the manifold in a direction that is at least partially parallel to a longitudinal axis of the machining tool when the manifold is in the extended configuration.

24. A method of machining, the method comprising:
moving a manifold including one or more nozzles disposed thereon from a first retracted configuration spaced apart from a first machining tool towards a second extended configuration;
passing the first machining tool through a gap formed in the manifold into an interior opening of the manifold as the manifold is moved from the first retracted configuration towards the second extended configuration such that the first machining tool extends through the interior opening of the manifold when the manifold is in the second extended configuration; and
directing supercritical fluid to a machining interface via one or more nozzles of the manifold, wherein the one or more nozzles comprise a plurality of nozzles that includes a first group of nozzles directed towards a first focal location and a second group of nozzles directed towards a second focal location different from the first focal location.

25. The method of machining of claim 24, wherein moving the manifold from the first retracted configuration towards the second extended configuration includes a lateral movement of the manifold relative to a longitudinal axis of the first machining tool.

26. The method of claim 23, wherein the manifold at least partially surrounds the machining tool when the manifold is in the second extended configuration

27. The method of claim 23, wherein the manifold surrounds at least 50% of a cross sectional perimeter of the machining tool when the manifold is in the second, extended configuration.

28. The method of claim 23, further comprising delivering a supercritical machining fluid to the manifold when the manifold is in the second extended configuration and emitting one or more flows of the supercritical machining fluid towards the first machining tool and/or a machining interface from one or more nozzles of the manifold.

29. The fluid distribution system or method of claim 23, wherein the one or more nozzles include three or more nozzles distributed around a perimeter of the interior opening.

30. A method, comprising:
obtaining a location of a machining interface; and
based at least in part on the machining interface location, changing a trajectory of one or more flows of supercritical machining fluid directed from a manifold towards the machining interface location.

31-40. (canceled)

41. A fluid distribution system comprising:
a manifold;
one or more nozzles disposed on the manifold;
one or more actuators configured to control a position of the manifold relative to a machining tool holder configured to retain a machining tool therein; and
at least one processor configured to perform the method of claim 23.

42. (canceled)

43. A method, comprising:
directing one or more flows of supercritical machining fluid from a manifold towards a machining interface;
obtaining a property of the machining interface; and
controlling a flow parameter of the one or more flows of supercritical machining fluid based at least in part on the machining interface property.

44. A method, comprising:
directing one or more flows of supercritical machining fluid from a manifold towards a machining interface;
obtaining a property of the machining interface; and
controlling machining of the machining interface based at least in part on the machining interface property.

45-52. (canceled)

53. A fluid distribution system comprising:
a manifold;
one or more nozzles disposed on the manifold and configured to direct one or more flows of supercritical machining fluid from the manifold towards a machining interface;
one or more sensors configured to sense the property of the machining interface; and
at least one processor configured to control operation of the manifold and one or more nozzles to perform methods of claim 43.
